(19) United States
(12) Patent Application Publication
(10) Pub. No.: US 2009/0228358 A1
(43) Pub. Date: Sep. 10, 2009

(54) Method and system of advertising, sales and acquiring and measuring market data using wireless device

(76) Inventor: Thomas Hiramatsu Tie, Concord, CA (US)

Correspondence Address: Thomas Hiramatsu Tie, 960 Stimel Drive, Concord, CA, 94518, US

(21) Appl. No.: 12/380,843

(22) Filed: Mar. 3, 2009

Related U.S. Application Data
(60) Provisional application No. 61/068,488, filed on Mar. 6, 2008.

(51) Int. Cl. G06Q 30/00; G06Q 90/00

(52) U.S. Cl. 705/14; 705/26

(57) ABSTRACT

The present invention is a method and system by which consumers may search the global marketplace for particular products or services, receive advertisements and receive notifications when specific products or services are placed on sale or are being offered at a particular price using the consumer's mobile device, personal device assistant or other wireless device. Furthermore, the method and system of the present invention can be used to acquire market data, including data reflecting the effectiveness of a particular advertising campaign, sales campaign, product placement strategy or a particular consumer's affinity for a certain type of product or service in order to determine what other related products or services may be of interest to the consumer.

### PRIORITY CLAIM

This application claims priority to and the benefit of the filing date of corresponding U.S. Provisional Application No. 61/068,488, filed on Mar. 6, 2008, the disclosure and contents of which are expressly incorporated herein by reference.

### FIELD OF THE INVENTION

The present invention relates to a method and system by which consumers may search the global marketplace for particular products or services, receive advertisements and receive notifications when specific products or services are placed on sale or are being offered at a particular price using the consumer's mobile device, personal device assistant or other wireless device. Furthermore, the method and system of the present invention can be used to acquire market data, including data reflecting the effectiveness of a particular advertising campaign, sales campaign, product placement strategy or a particular consumer's affinity for a certain type of product or service in order to determine what other related products or services may be of interest to the consumer.

### BACKGROUND OF THE INVENTION

Over recent years, there has been a major global proliferation of the use of various wireless and mobile devices [e.g. cellular telephones and personal device assistants (PDAs)] by not only the business and professional community, but also by average, everyday people. As a result, the complexity of these devices is also rapidly increasing to incorporate a number of functions and applications. As of Feb. 22, 2008, there was an estimated two billion plus mobile telephone subscribers in the world and over 200 million in the United States alone. The volume of mobile phone subscribers is much larger than the number of personal computers (PCs) in use around the world today, which is estimated to be at 575 million.

Other than serving as a verbal communication tool between users, these wireless mobile devices are also being used to directly relay information to the user, such as news and weather reports, the location of a particular place or event and directions on how to reach that destination, and various forms of entertainment such as video games. The majority of the information that is relayed to the user is in response to the user's own initiated request or search.

Therefore, these wireless mobile devices have become a very desirable tool for the media, retail outlets, advertising agencies and public relations firms, etc. for disseminating advertisements and information to users. For example, an electronic advertisement may be relayed to the user through a text message or web browser image when the user conducts a search for information related or not related to the content of the advertisement. The relayed information is either superseded by the advertisement or the advertisement is inserted into the relayed information itself. However, most users prefer not to receive advertisements on their personal wireless devices, particularly when the user is charged for receiving the advertisement or when the advertisement interferes with the user's own initiated search, request or entertainment program. Therefore, the majority of users are either against receiving any advertisements on their wireless mobile devices or are willing to receive advertisements if the cost of the advertisement or the interrupted search or entertainment program is paid for by someone other than the user. This behavior suggests that a user's tolerance for advertisements sent and received over their wireless mobile device is influenced by the following: (1) a user is only interested in content that the user is already actively searching for and (2) a user is more likely to accept and view advertisements if there is some form of incentive or compensation for receiving the advertisement. Thus, an advertising method and system that incorporates these two characteristics would likely be much more effective than the existing methods and systems of sending unsolicited advertisements to wireless mobile devices as a precondition for users to search for and receive information using their wireless mobile device.

Accordingly, there is a need in the art to provide an efficient advertising method and system that is operated over a wireless communications network and transforms a wireless mobile device to allow the user of that device to directly and actively participate in the advertising, sales or marketing scheme, rather than being a passive recipient of random advertisements.

Therefore, an object of the present invention is to provide an advertising method and system in which the advertisement itself is the content or is related to the content that the user is actively searching for or requesting through his or her wireless mobile device.

It is a further object of the present invention to provide an advertising method and system in which the advertisement itself provides a form of compensation or an incentive for the user to accept the advertisement

It is a further object of the present invention to provide an advertising method and system that minimizes the nature and amount of personal identification information that the user must disclose in order to receive the advertisement.

It is a further object of the present invention to provide an advertising method and system that is used to acquire market data and feedback that advertisers may use to increase the effectiveness of their advertising or marketing strategies, including data reflecting the effectiveness of a particular advertising or sales campaign, product placement strategy or a particular consumer's affinity for a certain type of product or service in order to determine what other related products or services may be of interest to the consumer.

### SUMMARY OF THE INVENTION

The present invention resolves the above-described problems by providing a method and system by which consumers may search the global marketplace for particular products or services of their specific interest, receive advertisements and receive notifications when specific products or services are placed on sale or are being offered at a particular price using the consumer's mobile device, personal device assistant or other wireless device. Furthermore, the method and system of the present invention can be used by sellers to acquire market data, including data reflecting the effectiveness of the seller's particular advertising campaign, sales campaign, or product placement strategy, and to understand the behavioral patterns and other characteristics of the relevant consumers.

After a consumer has identified a particular product or service of interest, the consumer may register the unique identification code associated with the consumer's wireless mobile device (e.g. telephone number) and the unique identification code associated with the product or service (e.g. a barcode number) of interest with the seller at either the seller's retail store or online website such that it is stored in the seller's product and/or service database using the seller-operated methods for data entry and maintenance. By registering these two identification codes and no other personal information, the consumer agrees to receive targeted notifications or other types of advertisements for the product or service of interest and/or related products or services of interest from the seller. These notifications may include, but are not limited to, alerts or redeemable coupons offering discounts or other types of purchase incentives for the particular product or service.

At the seller's initiative, the particular product and/or service identified by the consumer to be of interest may be at some point in time the subject of a specific advertising, sales or marketing campaign of the seller's overall marketing strategy. The seller may decide to specifically promote or place on sale the particular product and/or service on the basis of its inventory or marketing plan or as a result of the data the seller receives from the registered wireless mobile device codes, which have been registered in connection with the particular product and/or service.

The seller will notify the consumer, by a notification or other type of advertisement, of its specific advertising, sales or marketing campaign through the consumer's wireless mobile device in the format chosen by the consumer, such as by a text message, voicemail message, video message, e-mail message or other methods of communication. When the consumer purchases the product or service that was the subject of the notification, the consumer's wireless mobile device code is identified and may be used to redeem a discount or other incentive option or offer that was relayed to the consumer for purchasing the product or service.

Once the consumer purchases the product or service of interest, or otherwise notifies the seller that the consumer is no longer interested in receiving notifications in connection with the product or service, or the seller has ended its sales campaign in connection with the product or service, the seller is thereafter prohibited by the agreement to contact the consumer with any further advertisements or notifications, unless the consumer reinitiates the process in regards to the same or a different product or service of interest.

The present invention also allows the seller to analyze and utilize the registration and subsequent purchase data stored in its database to adjust, maintain or create its advertising, marketing or sales campaign with respect to the product and/or service of interest or related products and/or services. For example, after the seller has implemented its advertising, marketing or sales campaign, the seller will be able to measure the success of its advertising, marketing or sales campaign and will have direct and substantiated data regarding the number of purchases made of the product or service in direct response to the number of notifications or other advertisements that were sent to the registered wireless mobile device codes. This data can be analyzed in a number of ways and can be used as a tool for the seller's future advertising, marketing and sales campaigns.

### BRIEF DESCRIPTION OF THE DRAWINGS

FIG. 1 is a flow chart of an embodiment of the method and system of the present invention.

FIG. 2 is a system architecture diagram of an embodiment of the method and system of the present invention.

### DETAILED DESCRIPTION OF THE INVENTION

In order to improve the effectiveness of utilizing wireless mobile devices as powerful and efficient marketing and advertising tools and the desirability of the recipients for receiving advertisements on their wireless mobile devices by focusing specifically on the objectives of the consumer, the present invention provides a method and system by which consumers may search the global marketplace for particular products or services, receive advertisements and receive notifications when specific products or services are placed on sale or are being offered at a particular price using the consumer's mobile device, personal device assistant or other wireless device. While the present invention will be described more fully hereinafter with reference to the accompanying drawings, in which a preferred embodiment of the present invention is shown, it is to be understood at the outset of the description which follows that persons of skill in the appropriate arts may modify the invention herein described while still achieving the favorable results of this invention. Accordingly, the description which follows is to be understood as being a broad, teaching disclosure directed to persons of skill in the appropriate arts, and not as limiting upon the present invention.

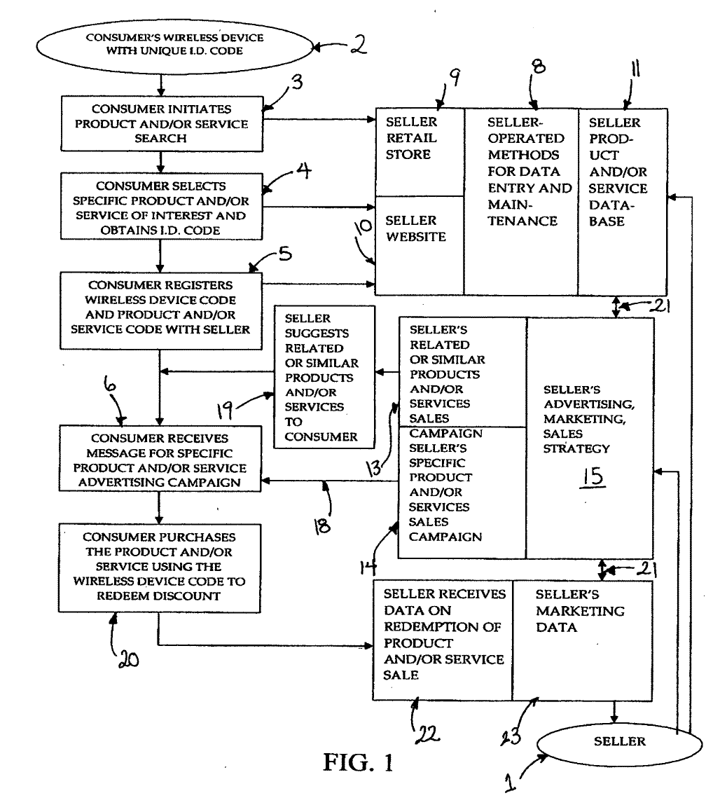

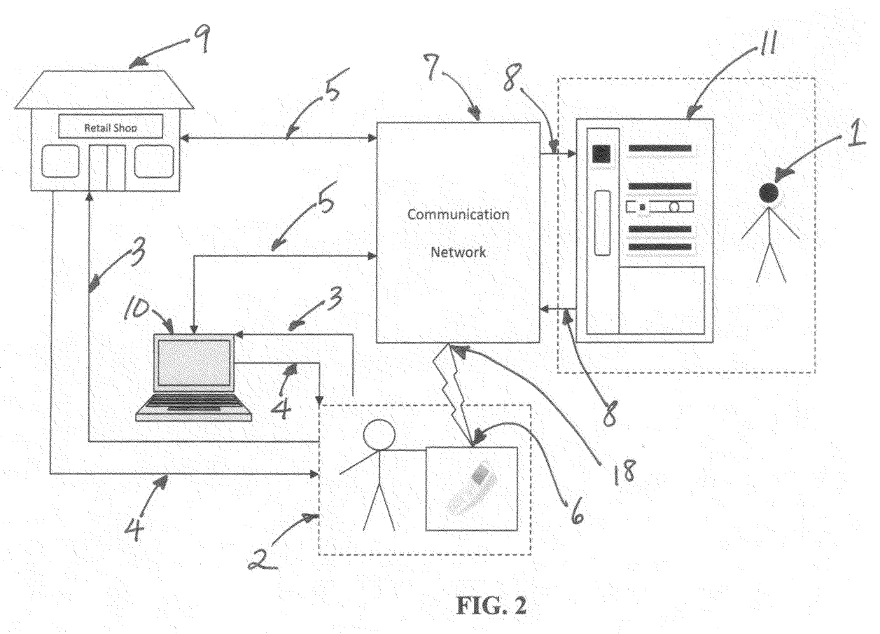

FIGS. 1 and 2 depict an embodiment of the present invention, in which the advertising and sales campaign source is a seller 1 of retail products and/or services and the recipient of the advertising and sales campaign information is a retail consumer who owns a wireless mobile device 2. As is standard with all existing wireless devices, such as mobile cellular phones, each device has its own unique identification code, such as a telephone number, a barcode marking, or another type of code which may be advantageously utilized by the present invention as a unique identification code for a particular recipient. In addition, most sellers' products that are currently sold have a unique product identification code in alphanumeric, barcode, or other recognizable identification marker for shipping, inventory, consumer protection and other purposes that may also be used by the present invention in order to identify a particular product and/or service. Using the two identification codes for a particular recipient and a particular product and/or service, the consumer and the seller may form an agreement for the consumer to receive a targeted advertisement from the seller for a product or service of the consumer's interest without the need for the consumer to release any other personal identification information.

A consumer first initiates the process by searching 3 through the products and/or services that are available for sale or advertised at a retail store 9 and/or at an online website 10 that is operated or affiliated with the seller 1. Once the consumer identifies or selects a specific product or service of interest, the consumer obtains the unique identification code of that product or service 4. Thereafter, the consumer registers 5 the unique identification code of his or her wireless mobile device 2 (e.g. telephone number) and the unique identification code of the product or service (e.g. barcode number) of interest with the seller in order to receive information about the product including, but not limited to, a notification when the product or service is being offered at a specific or discounted price, a redeemable coupon that may be used by the consumer to obtain a discount for the product or service, or advertisements for related products and/or services. Therefore, any information that is sent to the consumer's wireless mobile device is a result of registering the unique identification code of his or her wireless mobile device and has been initiated by and agreed to by the consumer. In order to register the unique identification code of the consumer's wireless mobile device and the unique identification code of the product or service of interest, the information is entered into a portal and stored in the seller's product and/or service database 11 using the seller-operated methods for data entry and maintenance 8 that are provided for by software that is either developed or modified to fulfill these functions. Advantageously, using this method and system, a consumer may register the same product or service identification number with more than one seller in order to beneficially receive competing offers or advertisements on the same product or service.

At the seller's initiative, the particular product and/or service identified by the consumer to be of interest may be at some point in time the subject of a specific advertising, sales or marketing campaign 14 of the seller's overall advertising, marketing or sales strategy 15. For example, the seller may decide to place that product and/or service on sale or offer some type of incentive in connection with purchasing that product and/or service. As a part of its advertising, sales or marketing campaign, the seller, using a wireless communications network 7, may then send 18 a notification or other type of advertisement of the campaign to the unique identification codes of the wireless mobile devices that have been registered in connection with the unique identification code of the particular product and/or service. Thereafter, the notification or other type of advertisement is received 6 by the consumers associated with each of the device identification codes. The notification or other type of advertisement may, for example, alert the consumer as to when the product or service is being offered at a specific or discounted price, provide a redeemable coupon that may be used by the consumer to obtain a discount for the product or service, provide a redeemable coupon or other incentive option that may be used if the consumer registers the unique identification code of his or her wireless mobile device in connection with a different product or service, or may consist of advertisements for related products and/or services.

The notification or other type of advertisement received 6 by the consumer may be in the format chosen by the consumer. For example, the notification may be in the form of a text message, voicemail message, e-mail message, video message, or conventional mail, etc. In addition, the notification may be in a standardized format or a customized format specified by the consumer.

In addition, the seller may be promoting as a part of its advertising, sales or marketing campaign, an updated version of the product or service or a related or similar product or service 13 to the specific product and/or service initially identified by the consumer that may be of interest to the consumer as an alternative or as a compliment to the product and/or service of interest and may be suggested by the seller 19. At the time of registering the wireless mobile device code and the identification code of the product or service of interest or during the consumer's initial search for a product or service of interest, the consumer may choose to also receive notifications or other types of advertisements regarding these related or similar products or services or other types of incentives.

When the consumer purchases a product or service, the consumer's wireless mobile device code is identified and may be used to redeem a discount or other incentive option or offer that was relayed to the consumer for purchasing the product or service 20. For example, a consumer, during a visit at a retail bookstore, may have identified a particular book that he or she was interested in receiving notifications and advertisements in connection with. After registering the unique code of the consumer's wireless mobile device and the unique product code of the book with the bookstore in accordance with the present invention, the bookseller, author, or publishing company, etc. may decide, based on the interest expressed in the book, to offer the book at a certain discounted price for a limited time and only to those consumers who have registered their wireless mobile device codes in connection with the book. A notification of the promotion, offer or sale is easily and immediately sent to and received by the consumer without the need for an extensive, expensive and wide-reaching advertising and promotional campaign. Within the limited time of the offer, the consumer may then present the consumer's wireless device code to the bookstore in order to purchase the book at the discounted price.

Once the consumer purchases the product or service of interest, or otherwise notifies the seller that the consumer is no longer interested in receiving notifications in connection with the product or service, or the seller has ended its sales campaign in connection with the product or service, the seller is thereafter prohibited by the agreement to contact the consumer with any further advertisements or notifications, unless the consumer reinitiates the process in regards to the same or a different product or service of interest.

From the viewpoint of the seller, there are a number of advantages in utilizing the present invention as a tool to implement its advertising, marketing and sales campaigns. For example, the seller may monitor the number of wireless mobile device codes that have been registered and stored in the seller's product and/or service database in connection with a particular product or service in order to gauge the amount of direct interest or disinterest in the product or service in real time 21. The seller can also use this information or data 23 as a simple and efficient decision-making tool when making decisions regarding the parameters of its advertising, marketing and sales campaigns (e.g. time period of the campaign or product or service placement). This information or data can provide a feedback mechanism that can aid a seller in adapting to current market conditions or modifying or adjusting its current marketing strategy. The seller can also use this information or data to determine its inventory needs for the particular product or service.

In another example, because the interest in a particular product or service and the seller's notification or other advertisements are all communicated over the wireless mobile devices, a seller can make an instantaneous decision to place a product or service on sale and the sale will not be subject to delays resulting from highly structured analysis, preparation and the scheduling of televised, radio, printed or other methods of advertising and communications.

In addition, after the seller has implemented its advertising, marketing or sales campaign, the seller will be able to measure the success of its advertising, marketing or sales campaign and will have direct and substantiated data 22 regarding the number of purchases made of the product or service in direct response to the number of notifications or other advertisements that were sent to the registered wireless mobile device codes. This data 22 can be analyzed in a number of ways and can be used as a tool 23 for the seller's future advertising, marketing and sales campaigns. For example, the seller may be able to determine how the price of the product or service affects the amount of interest in the product or service and the number of consumers who redeem a discount notification or other type of purchase incentive that was received on their wireless mobile devices. As an analytical tool, the seller may also be able to determine the most appropriate discount percentage to offer, whether to classify a particular product or service as standard or luxury, the existence of or the effect of competition on the seller's sales, or determining the behavioral patterns or characteristics of the consumers.

Accordingly, it will be understood that one embodiment of the present invention has been disclosed by way of example and that other modifications and alterations may occur to those skilled in the art without departing from the scope and spirit of the appended claims.

I claim:

1. A method for advertising, sales and acquiring and measuring market data, comprising:
inputting into a portal a unique identification code of at least one consumer's wireless mobile device upon the consumer's consent;
inputting into said portal a unique identification code of a product or service offered for sale by a seller and chosen by the at least one consumer to be of interest such that the identification code is associated with the unique identification code of the at least one consumer's wireless mobile device;
storing each of said identification codes in at least one database that is in communication with said portal; and
sending a notification from the seller to the at least one consumer's wireless mobile device over a wireless communications network regarding the product or service.

2. The method of claim 1 further comprising identifying said identification code of the at least one consumer's wireless mobile device when the at least one consumer purchases the product or service from the seller.

3. The method of claim 2 further comprising generating data that is used by the seller to correlate said notification sent to the at least one consumer's wireless mobile device with the consumer's purchase of the product or service.

4. The method of claim 1 wherein the wireless mobile device is a cellular telephone or a personal device assistant.

5. The method of claim 1 wherein the unique identification code of the at least one consumer's wireless mobile device is the telephone number associated with the device.

6. The method of claim 1 wherein the unique identification code of the product or service is comprised of an alphanumeric code or a barcode.

7. The method of claim 1 wherein said portal is located at the seller's retail store.

8. The method of claim 1 wherein said portal is located at the seller's online website.

9. The method of claim 1 wherein said notification is comprised of an advertisement.

10. The method of claim 1 wherein said notification is comprised of an alert to the consumer when the product or service is being offered by the seller at a specific price.

11. The method of claim 1 wherein said notification is comprised of a redeemable discount offer or other purchase incentive offer.

12. The method of claim 1 further comprising suggesting at least one product and/or service that is offered for sale by the seller and is related to the product or service chosen by the consumer to be of interest.

13. The method of claim 1 further comprising generating data that is used by the seller to determine the amount of direct interest or disinterest in the product or service in real time based upon the number of identification codes of the consumers' wireless mobile devices stored in said database that are associated with the product or service.

14. The method of claim 3 wherein the generated data allows the seller to measure the effectiveness of the seller's advertising, marketing or sales campaign regarding the product or service.

15. A method for advertising, sales and acquiring and measuring market data, comprising:
inputting into a portal a unique identification code of at least one consumer's wireless mobile device upon the consumer's consent;
inputting into said portal a unique identification code of a product or service offered for sale by a seller and chosen by the at least one consumer to be of interest such that the identification code is associated with the unique identification code of the at least one consumer's wireless mobile device;
storing each of said identification codes in at least one database that is in communication with said portal;
sending a notification from the seller to the at least one consumer's wireless mobile device over a wireless communications network regarding the product or service;
identifying said identification code of the at least one consumer's wireless mobile device when the at least one consumer purchases the product or service from the seller, and generating data that is used by the seller to correlate said notification sent to the at least one consumer's wireless mobile device with the consumer's purchase of the product or service.

16. The method of claim 15 wherein said notification is comprised of an advertisement.

17. The method of claim 15 wherein said notification is comprised of an alert to the consumer when the product or service is being offered by the seller at a specific price.

18. The method of claim 15 wherein said notification is comprised of a redeemable discount offer or other purchase incentive offer.

19. The method of claim 15 further comprising suggesting at least one product and/or service that is offered for sale by the seller and is related to the product or service chosen by the consumer to be of interest.

20. The method of claim 15 wherein the generated data allows the seller to measure the effectiveness of the seller's advertising, marketing or sales campaign regarding the product or service.

21. A system for advertising, sales and acquiring and measuring market data, comprising:
at least one consumer's wireless mobile device having a unique identification code associated with the wireless mobile device;
a product or service offered for sale by a seller and chosen by the at least one consumer to be of interest and having a unique identification code associated with the product or service;
a portal wherein the unique identification code of the wireless mobile device and the unique identification code of the product or service is entered into the portal such that the unique identification code of the wireless mobile device is associated with the unique identification code of the product or service;
at least one database that is in communication with said portal wherein said identification codes are stored in the database; and
a wireless communications network that is in communication with the at least one database and the at least one wireless mobile device such that a notification is sent using the wireless communications network from the seller to the at least one wireless mobile device regarding the product or service.
